(19) United States
(12) Patent Application Publication
(10) Pub. No.: US 2005/0198264 A1
(43) Pub. Date: Sep. 8, 2005

(54) Dynamic selection of behavior sets for middleware

(76) Inventors: Tyrone D. Bekiares, Chicago, IL (US); Matthew C. Keller, Algonquin, IL (US); Vidya Narayanan, Schaumburg, IL (US); George Popovich, Palatine, IL (US)

Correspondence Address: MOTOROLA, INC., 1303 EAST ALGONQUIN ROAD, IL01/3RD, SCHAUMBURG, IL, 60196, US

(21) Appl. No.: 10/767,486

(22) Filed: Jan. 29, 2004

(51) Int. Cl. G06F 15/173

(52) U.S. Cl. 709/224; 709/225

(57) ABSTRACT

A method for use by middleware in a communication system (100) that includes the steps of: enabling a group of behavior sets (220) for use by the middleware; operating (330) in accordance with a first behavior set from the group (220); receiving at least one trigger (342, 346); selecting (350) a second behavior set from the group (220) based upon the at least one trigger (342, 346); and operating in accordance with the second behavior set (330).

### FIELD OF THE INVENTION

The present invention relates generally to communication systems and more specifically to dynamically switching between two or more behavior sets for middleware based on one or more triggers.

### BACKGROUND OF THE INVENTION

Many communication systems include middleware. Middleware, as used herein, may be defined as software or hardware that serves to “glue together” or mediate between one or more applications running on a device in the system and one or more communication network transports. Middleware adhering to this definition typically includes functionality related to mobility, authentication, authorization, optimization, and encryption. The middleware may be included on either or both the subscriber side of the communication system, i.e., middleware client, and the infrastructure side of the communication system, i.e., middleware server.

FIG. 1 illustrates a communication (or data) system 100 that includes middleware. System 100 may be, for instance, a public safety data system. System 100 includes a middleware client 16 and a middleware server 40. System 100 is shown as having a single middleware server and a single middleware client for simplicity. However, those of ordinary skill in the art will realize that a communication system would typically have a plurality of both elements.

The middleware client 16 may be a hardware device (as illustrated in FIG. 1) that is coupled to a data terminal 12 that is a part of system 100. This coupling may be by way of, for instance, a wired cable connection or a short range wireless communication network transport. The middleware client 16 may also be, and is typically, software that may be run on the hardware device (16) or on data terminal 12. Data terminal 12 may be, for instance, a laptop computer (as illustrated in FIG. 1), a personal digital assistant or other data terminal that may run one or more applications 14 such as, for instance, a Computer-Aided Dispatch (CAD) application, a web browser, a multimedia client, and/or an electronic messaging client.

Middleware client 16 is also further coupled to one or more communication network transports 20 such as, for instance, a wireless local area network (WLAN), a private network and a public network via a plurality of wireless resources 30. Thus, the middleware client 16 serves to mediate between applications 14 and networks 20.

The middleware server 40 may be a hardware device (as illustrated in FIG. 1) that is coupled to a customer enterprise network 50 that is a part of system 100. This coupling is typically via a wired cable connection. The middleware server 40 may also be, and is typically, software that may be run on the hardware device (40) or on some other device such as, for instance, a server included in the customer enterprise network 50. The customer enterprise network 50 may be, for instance, a communication network that may host one or more applications 52 such as, for instance, Computer-Aided Dispatch (CAD), web content, multimedia services, and/or electronic messaging services. The middleware server 40 is also further coupled to networks 20, thereby, serving to mediate between applications 52 and networks 20.

Many older data systems, for instance many public safety systems, were designed to transport specific application data (e.g. CAD) over a single low speed communication network transport. This simplistic design ensures a known Quality of Service (QoS), since both the application and communication network transport characteristics are well defined. Conversely, newer data systems (for both public safety and other markets) will likely be comprised of a suite of complimentary communication network transport technologies. Furthermore, the higher throughput offered by some of these communication network transports will allow users to run multiple low bandwidth (e.g. CAD) and high bandwidth (e.g. multimedia) applications simultaneously to create, in effect, a mobile office.

However, current middleware is ill-suited to address some of the routing and QoS issues that may arise in such heterogeneous data systems. More specifically, for instance, users will now have the capability to run applications within their mobile office that may not be optimized for wireless connections, thereby generating additional and unpredictable traffic ultimately corresponding to a decreased QoS. While this decreased QoS may be an acceptable tradeoff under normal circumstances, there may be other instances, such as mission critical situations, for instance in the public safety market, where this decreased QoS is considered unacceptable. A mission critical situation or state is herein defined as a situation or state requiring a heightened level of alert or attention.

Consider, for example, a customer whose communication system is comprised of both a public data communication network transport and a private integrated voice and data communication network transport. The two communication network transports partially overlap in coverage, with ubiquitous coverage provided by the private communication network transport. Under normal circumstances, the customer may favor access to the public communication network transport when in range of both because of its potentially higher throughput. When a user drives into an area not serviced by the public provider, the middleware client will switch to the private communication network transport. However, when operating in certain situations, for example in a mission critical situation, the customer may want to activate a behavior set in the middleware that restricts communications solely to a single application such as CAD coupled exclusively to the private communication network transport. The private communication network transport will likely be much less susceptible to outages (caused perhaps by a loss of electricity in a disaster situation) and will likely offer better encryption, security, and message transfer reliability. Furthermore, restricting communication to a single communication network transport will help minimize data loss during handover and thus provide more continuous coverage. In another example, the customer may wish to activate a behavior set in the middleware that blocks certain types of background traffic such as database updates in mission critical situations in an effort to reduce traffic load on the communication network transports.

Current middleware offerings cannot accommodate a dynamic change in behavior sets and corresponding QoS, much less the ability to asses the mission criticality of a situation. This is because the middleware solutions available today have provisions to follow only a single set of predefined behaviors. These behaviors are herein defined as a set of rules which dictate, on a per-packet basis, how data is routed, blocked, or modified from an application to a communication network transport. A change in these behaviors requires a local or remote administrator to reprogram and replace the current behavior set, and it is not possible to dynamically change behavior sets without critically interrupting the flow of data between the applications and the communication network transports. As such, middleware clients are typically programmed with a behavior set appropriate for situations most encountered, which is typically ill-suited for special situations such as mission critical situations. In general, this default behavior set will likely favor higher throughput above all other factors, whereas other situations, such as mission critical situations, typically demand reliable communications at the expense of other factors.

Thus, there exists a need for middleware that has provisions for two or more behavior sets and corresponding QoS to be defined and that has the capability of dynamically switching between these behavior sets based upon one or more triggers.

### BRIEF DESCRIPTION OF THE FIGURES

A preferred embodiment of the invention is now described, by way of example only, with reference to the accompanying figures in which:

FIG. 1 illustrates a diagram of a communication system that may implement an embodiment of the present invention;

FIG. 2 illustrates a middleware client in accordance with an embodiment of the present invention;

FIG. 3 illustrates a method in accordance with an embodiment of the present invention for use in the middleware client illustrated in FIG. 2;

FIG. 4 illustrates a middleware server in accordance with an embodiment of the present invention; and

FIG. 5 illustrates a method in accordance with an embodiment of the present invention for use in the middleware server illustrated in FIG. 4.

### DETAILED DESCRIPTION OF THE INVENTION

While this invention is susceptible of embodiments in many different forms, there are shown in the figures and will herein be described in detail specific embodiments, with the understanding that the present disclosure is to be considered as an example of the principles of the invention and not intended to limit the invention to the specific embodiments shown and described. Further, the terms and words used herein are not to be considered limiting, but rather merely descriptive. It will also be appreciated that for simplicity and clarity of illustration, elements shown in the figures have not necessarily been drawn to scale. For example, the dimensions of some of the elements are exaggerated relative to each other. Further, where considered appropriate, reference numerals have been repeated among the figures to indicate corresponding elements.

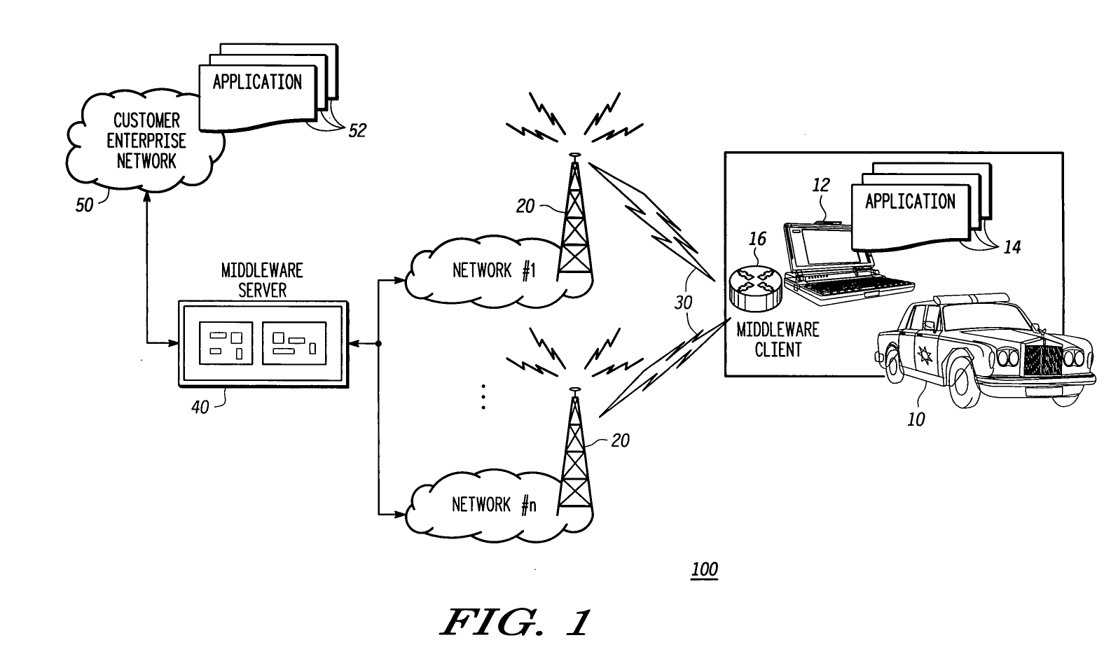

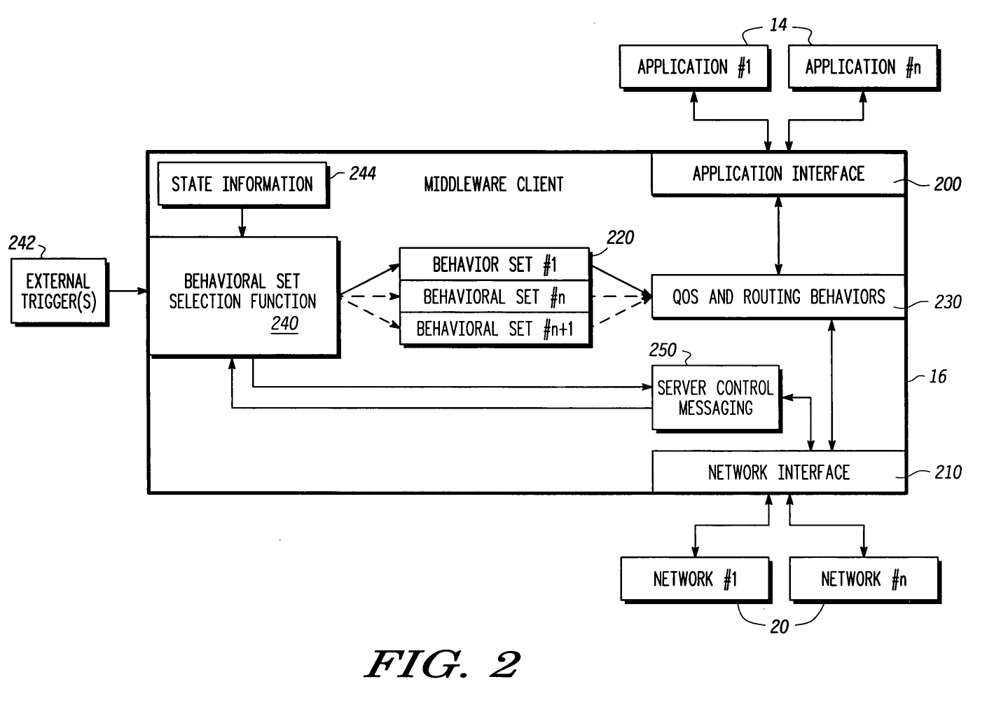

FIG. 2 illustrates an exploded view of the middleware client 16 included in the communication system 100 of FIG. 1 and configured in accordance with an embodiment of the present invention. As illustrated in FIG. 1 and in FIG. 2, the middleware client 16 serves to mediate between one or more applications 14, i.e., applications 1 through n, and one or more communication network transports 20, i.e., communication network transports 1 through n.

Middleware client 16 includes a suitable application interface 200 and a suitable network interface 210 for enabling communication, respectively, with the applications 14 and the communication network transports 20. The middleware client 16 further comprises a group of at least two predefined behavior sets 220, i.e. behavior sets 1 through n, which may be activated for controlling how the middleware client 16 performs its mediation functions between the applications 14 and the communications network transports 20. For instance, once a given behavior set is activated, the selected behavior set determines corresponding QoS and routing behaviors 230 of the middleware client 16.

The middleware client 16 also typically comprises a behavioral set selection function 240 that includes intelligence for determining the behavior set from the group 220 in accordance with which the middleware client 16 will operate at any given time. Function 240 makes its behavior set selection based upon at least one of: an external trigger 242; state information 244; and a remote trigger (not shown). Behavioral set selection function 240 is a programmable logic entity whose output, a selected behavior set, is determined by some logic evaluation of active input signals. These input signals can include external triggers 242, previous and current state information 244 related to the operation of middleware client, or a remote trigger. These input signals are evaluated according to pre-programmed logic to produce a behavioral set selection.

Thus, in operation, the behavioral set selection function 240 may determine whether a condition exists that causes it to change behavior sets in the middleware client 16 based upon either one of or a combination of external triggers 242, state information 244 and remote triggers. The middleware client 16 may also or alternatively be configured such that the assessment of a condition that exists that warrants a change in the middleware client's behavior set may be determined external to the behavioral set selection function 240 and communicated to it via the external triggers 242 or via remote triggers.

For instance, the behavioral set selection function 240 may assess that a mission critical condition or state exists that causes it to change behavior sets. Moreover, the behavioral set selection function 240 may be further configured to assess different levels of mission criticality, each dictating the selection of a different behavior set. In addition or alternatively the middleware server 40 may assess a mission critical situation and send a corresponding remote trigger to the middleware client 16. Upon receipt of this remote trigger, the middleware client 16 would then select the behavior set that corresponds to a mission critical situation or to a certain level of mission criticality for operation in accordance thereto. It should be further understood by those of ordinary skill in the art that the assessment of, for instance, mission criticality, or some other condition that warrants a change in the middleware client's behavior set may be performed manually by a user or administrator and communicated to the middleware client via an external or remote trigger.

A trigger is defined herein as a change in monitored conditions or parameters. Triggers may include, but are not limited to, a light bar being activated or deactivated on a public safety vehicle (e.g., a vehicle 10 in FIG. 1), a change in the time of day, the speed of the public safety vehicle, location information, an emergency button activation or deactivation, and a siren activation or deactivation. These triggers are examples of external triggers 242. However, the behavioral set selection function 240 may also receive one or more remote triggers, for instance from the middleware server 40. Remote triggers from the middleware server 40 may, for instance, be communicated to the behavioral set selection function 240 via server control messaging 250 coupled between it and the network interface 210. Server control messaging 250 terminates the control plane messaging between the middleware client 16 and middleware server 40. It is typically used to conduct authorization, registration, and other out-of-band data exchanges between the middleware client and server. The middleware server 40 can also use this data conduit to pass remote triggers to the middleware client 16. Once the trigger has been decoded and identified by server control messaging 250, it is passed to the behavioral set selection function 240 for assessment.

State Information 244 stores a portion of or all of the all previous and current state information related to the operation of middleware client 16. If programmed accordingly, the behavioral set selected by the behavioral set selection function 240 may be influenced by previous trigger information and characteristics of previously selected behavioral sets by way of state information 244.

The behavior sets and operation of the behavioral set selection function 240 are generally predefined based upon a customer's operational requirements and may be, for instance, programmed and downloaded into the middleware client 16 from the middleware server 40. Those of ordinary skill in the art will realize that the predefined behavior sets may also be preprogrammed into the middleware client 16. This enables individual customers to program the behavioral set selection function 240 with the conditions and corresponding activating triggers upon which the middleware client 16 should change behavioral sets. Accordingly, for instance, this enables customers to define what constitutes a mission critical situation and the triggers that should cause the middleware client 16 to detect such a condition. Those of ordinary skill in the art will realize that one or more of the behavior sets may also dynamically determined based upon, for instance, measured field conditions of communication network transports.

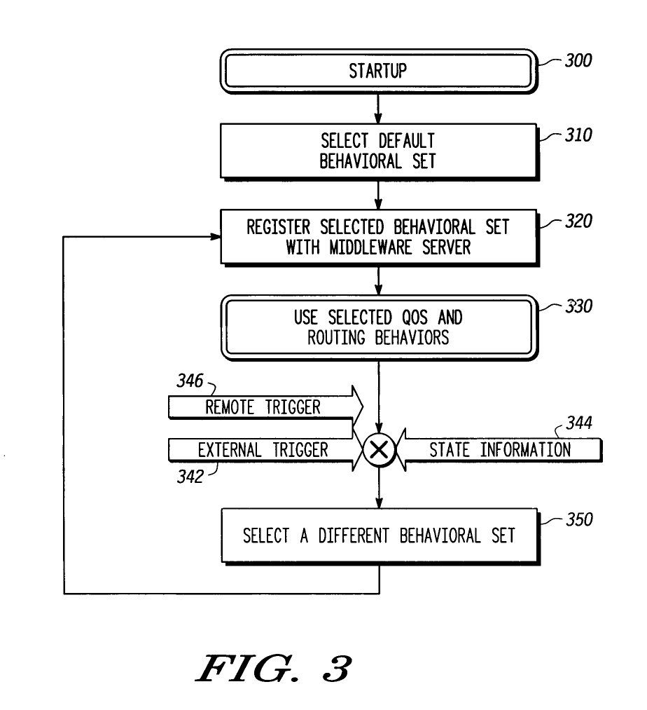

FIG. 3 illustrates a method in accordance with the present invention that may be implemented, for instance in the middleware client illustrated in FIG. 2. Accordingly, upon startup (300), for instance, of the middleware client 16, it selects (310) a behavior set from the group 220 which determines the corresponding QoS and routing behaviors 230 of the middleware client 16. The initial behavior set selected at startup is typically a predetermined standard or default behavior set that the middleware client uses under normal day-to-day-situations. For instance, the default behavior set may favor higher throughput over all other factors. If the communication system includes a middleware server 40, the middleware client 16 may notify (320) the middleware server 40 of its behavior set selection, typically via the server control messaging function 250. This would enable the middleware server to operate in accordance with a corresponding behavior set, for instance, for consistency in the QoS and routing rules of inbound and outbound data traffic.

The middleware client 16 will then operate (330) in accordance with the default behavior set until it assesses a condition that causes it to change its behavior set (350) based upon either one of or a combination of external triggers 342, state information 344 and remote triggers 346. The middleware client 16 may, for instance, determine that a mission critical situation exists and select a behavior set that causes the middleware client 16 to operate in accordance with a QoS and routing rules that are appropriate for the mission critical situation or for the level of mission criticality that was detected. Once again, where the communication system includes a middleware server 40, the middleware client 16 may notify (320) the middleware server 40 of its behavior set change, typically through the server control messaging function 250. This would enable the middleware server to operate in accordance with a corresponding changed behavior set.

The flow diagram would then repeat itself, wherein the middleware client 16 would continue to monitor the triggers and the state information to determine whether a change in its behavior set is warranted. For instance, the middleware client 16 may determine that a different level of mission criticality exists, and thereby change its behavior set. Alternatively, the middleware client 16 may determine that a mission critical condition no longer exist, and thereby return to operating in accordance with the default behavior set.

Consider, for example, a public safety official assigned to traffic stop patrol. For the majority of the shift, the official is driving a routine pattern around a particular beat. During this time, the middleware coupled to the mobile data terminal is handing off network connectivity between a narrowband private data network and strategically placed broadband hot spots. The middleware default behavioral set in use permits the officer to concurrently check email, maintain disposition on CAD, and remotely monitor a neighborhood security camera for gang activity. At some point, the officer attempts to pull over a speeding motorist. The motorist does not stop, and the officer engages in a high speed pursuit. The middleware detects a condition of mission criticality when the light bar and siren are subsequently activated. The behavioral set selection function reads these trigger inputs and selects the appropriate predefined behavioral set. This new behavioral set locks the communication network transport to the highly reliable private data network. This prevents momentary loss of communication since the vehicle, traveling at high speeds, may be quickly handing off between the narrowband private data network and the broadband hot spots. Furthermore, the new behavioral set blocks email and video traffic, thereby improving the QoS of the CAD application. When the suspect is finally apprehended, the light bar and siren are deactivated, and the middleware returns to its default behavioral set. The middleware is now free to roam between the narrowband and broadband networks, and email and video traffic are allowed to once again traverse through to the communication network transports.

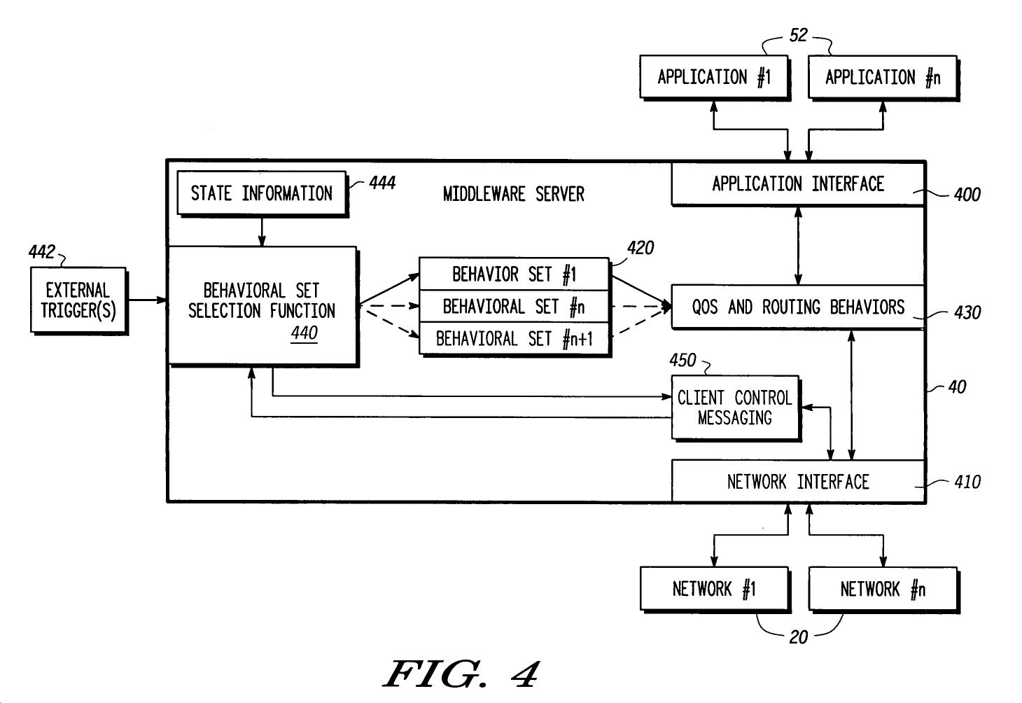

FIG. 4 illustrates an exploded view of the middleware server 40 included in the communication system 100 of FIG. 1 and configured in accordance with an embodiment of the present invention. As illustrated in FIG. 1 and in FIG. 2, the middleware server 40 serves to mediate between one or more applications 52, i.e., applications 1 through n, and one or more communication network transports 20, i.e., communication network transports 1 through n.

Middleware server 40 includes a suitable application interface 400 and a suitable network interface 410 for enabling communication, respectively, with the applications 52 and the communication network transports 20. The middleware server 40 further comprises a group of at least two predefined behavior sets 420, i.e. behavior sets 1 through n, which may be activated for controlling how the middleware server 40 performs its mediation functions between the applications 52 and the communications network transports 20. For instance, once a given behavior set is activated, the selected behavior set determines corresponding QoS and routing behaviors 430 of the middleware server 40.

The middleware server 40 also typically comprises a behavioral set selection function 440 that includes intelligence for determining the behavior set from the group 420 in accordance with which the middleware server 40 will operate at any given time. Function 440 makes its behavior set selection based upon at least one of: an external trigger 442; state information 444; and a remote trigger (not shown). Behavioral set selection function 440 is a programmable logic entity whose output, a selected behavior set, is determined by some logic evaluation of active input signals. These input signals can include external triggers 442, previous and current state information 444 related to the operation of middleware client, or a remote trigger. These input signals are evaluated according to pre-programmed logic to produce a behavioral set selection.

Thus, in operation, the behavioral set selection function 440 may determine whether a condition exists that causes it to change behaviors sets in the middleware server 40 based upon either one of or a combination of external triggers 442, state information 444 and remote triggers. The middleware server 40 may also or alternatively be configured such that the assessment of a condition that exists that warrants a change in the middleware server's behavior set may be determined external to the behavioral set selection function 440 and communicated to it via the external triggers 442 or via remote triggers.

For instance, the behavioral set selection function 440 may assess that a mission critical condition exists that causes it to change behavior sets. Moreover, the behavioral set selection function 440 may be further configured to assess different levels of mission criticality, each dictating the selection of a different behavior set. In addition or alternatively the middleware client 16 may assess a mission critical situation and send a corresponding remote trigger to the middleware server 40. Upon receipt of this remote trigger, the middleware server 40 would then select the behavior set that corresponds to a mission critical situation or to a certain level of mission criticality for operation in accordance thereto. It should be further understood by those of ordinary skill in the art that the assessment of, for instance, mission criticality, or some other condition that warrants a change in the middleware server's behavior set may be performed manually by a user or administrator and communicated to the middleware server via an external or remote trigger.

A trigger is defined herein as a change in monitored conditions or parameters. Triggers may include, but are not limited to, a change in the time of day, a change in communication network transport conditions and a dispatch alarm or warning. These triggers are examples of external triggers 442. However, the behavioral set selection function 440 may also receive one or more remote triggers, for instance from the middleware client 16. Remote triggers from the middleware client 16 may, for instance, be communicated to the behavioral set selection function 440 via client control messaging 450 coupled between it and the network interface 410. Client control messaging 450 terminates the control plane messaging between the middleware client 16 and middleware server 40. It is typically used to conduct authorization, registration, and other out-of-band data exchanges between the middleware client and server. When the middleware client 16 switches to a new behavioral set, it may indicate this switch to the middleware server as a remote trigger via client control messaging 450. Once the trigger has been decoded and identified by client control messaging 450, it is passed to the behavioral set selection function 440 for assessment.

State Information 444 stores a portion of or all of the previous and current state information related to the operation of middleware server 40. If programmed accordingly, the behavioral set selected by the behavioral set selection function 440 may be influenced by previous trigger information and characteristics of previously selected behavioral sets by way of state information 444.

The behavior sets and operation of the behavioral set selection function 440 are generally predefined based upon a customer's operational requirements and may be, for instance, programmed and downloaded into the middleware server 40 from the customer enterprise network 50. Those of ordinary skill in the art will realize that the predefined behavior sets may also be preprogrammed into the middleware server 40. This enables individual customers to program the behavioral set selection function 440 with the conditions and corresponding activating triggers upon which the middleware server 40 should change behavioral sets. Accordingly, for instance, this enables customers to define what constitutes a mission critical situation and the triggers that should cause the middleware server 40 to detect such a condition. Those of ordinary skill in the art will realize that one or more of the behavior sets may also dynamically determined based upon, for instance, measured field conditions of communication network transports.

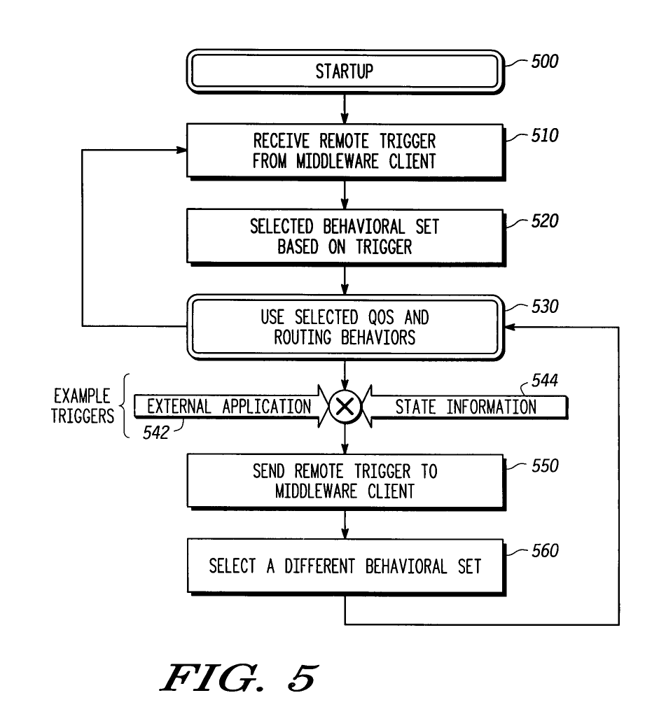

FIG. 5 illustrates a method in accordance with the present invention that may, for instance, be used in the middleware server 40 illustrated in FIG. 4. Those of ordinary skill in the art will realize that the middleware server 40 may also implement a method in accordance with the flow diagram illustrated in FIG. 3. In that case, the steps are the same as described above and will not be repeated here for the sake of brevity.

Returning to the flow diagram of FIG. 5, upon startup (500) of the middleware server 40, for instance, or while already in operation, the middleware server 40 may receive (510) a trigger, in this example a remote trigger from the middleware client 16. The trigger may, for instance, be communicated via the client control messaging function 450 in a registration request that identifies the middleware client's selected behavioral set. The middleware server 40 then selects (520) a behavior set for its operation, and employs (530) the corresponding routing behaviors and QoS. For example, as explained in detail above, the middleware client 16 may have assessed a mission critical situation and selected a corresponding behavior set for its own operation and thereafter notified the middleware server 40 via a remote trigger to the middleware server 40 so that the middleware server would accordingly change its behavior set for enabling consistent inbound and outbound routing of data with the appropriate corresponding QoS.

The middleware server 40 then continues to use its selected behavior set until it receives a trigger, for instance from the middleware client 16 via the client control messaging function, corresponding to an external assessment having been made that it should change its behavior set. Alternatively, the middleware server 40 may continue to use this behavior set until it makes that assessment internally based upon either one of or a combination of external triggers 542 and state information 544. The later half of the flow diagram illustrated in FIG. 3 illustrates the functionality of the middleware server making this assessment. Accordingly, the middleware server 40 might send (550) a remote trigger to the middleware client 16 for causing it to change its behavior set as a function of the assessment and select (560) a different behavior set for operation.

In the embodiments illustrated above, there is distributed intelligence between the middleware client 16 and the middleware server 40 for accessing a condition, such as mission criticality, wherein the behavior sets of both should be changed. However, those of ordinary skill in the art will realize that this intelligence may be located exclusively in either the middleware server or the middleware client or may be located external to both.

While the invention has been described in conjunction with specific embodiments thereof, additional advantages and modifications will readily occur to those skilled in the art. The invention, in its broader aspects, is therefore not limited to the specific details, representative apparatus, and illustrative examples shown and described. Various alterations, modifications and variations will be apparent to those skilled in the art in light of the foregoing description. Thus, it should be understood that the invention is not limited by the foregoing description, but embraces all such alterations, modifications and variations in accordance with the spirit and scope of the appended claims.

1. A method for use by middleware in a communication system comprising the steps of:
enabling a group of behavior sets for use by said middleware;
operating in accordance with a first behavior set from said group;
receiving at least one trigger;
selecting a second behavior set from said group based upon said at least one trigger; and
operating in accordance with said second behavior set.

2. The method of claim 1 further comprising the step of notifying a second middleware of the selecting of said second behavior set.

3. The method of claim 1, wherein said at least one trigger is at least one of:
a light bar activation;
a light bar deactivation;
a change in the time of day;
the speed of a vehicle;
location information;
an emergency bar activation;
an emergency bar deactivation;
an emergency button activation;
an emergency button deactivation;
a siren activation;
a siren deactivation;
a dispatch warning; and
a change in behavior set of a second middleware.

4. The method of claim 1, wherein said middleware is a middleware client.

5. The method of claim 1, wherein said middleware is a middleware server.

6. The method of claim 1, wherein said step of operating comprises implementing a set of routing rules and Quality of Service determined as a function of said second behavior set.

7. The method of claim 1, wherein said first behavior set is a default behavior set.

8. The method of claim 1, wherein said at least one trigger is at least one of a remote trigger and an external trigger.

9. The method of claim 1 further comprising the step of examining state information, and wherein said second behavior set is selected based upon said state information.

10. The method of claim 1, wherein said second behavior set is selected based upon a determination of a first condition.

11. The method of claim 10, wherein said first condition is a state of mission criticality.

12. The method of claim 10, wherein said determination of said first condition is made external to said middleware and communicated to said middleware via said at least one trigger.

13. The method of claim 12, wherein said determination of said first condition is made by a second middleware.

14. The method of claim 12, wherein said determination of said first condition is made manually.

15. The method of claim 10, wherein said determination of said first condition is made internal to said middleware based on said at least one trigger.

16. The method of claim 1, wherein at least one of the behavior sets in said group is predefined.

17. The method of claim 1, wherein at least one of the behavior sets in said group is dynamically determined.

18. A method for use in middleware in a communication system comprising the steps of:
enabling a group of behavior sets to be predefined for use by a first middleware;
operating in accordance with a first behavior set from said group;
receiving at least one trigger;
selecting a second behavior set from said group based upon said at least one trigger;
notifying a second middleware of the selecting of said second behavior set; and
operating in accordance with said second behavior set, said operating comprising implementing a set of routing rules and Quality of Service determined as a function of said second behavior set.

19. Middleware for mediating between at least one application and at least one communication network transport, said middleware comprising;
an application interface;
a network interface;
a group of behavior sets; and
a behavior set selection function operative for causing said middleware to operate in accordance with a first behavior set from said group; receiving at least one trigger; selecting a second behavior set from said group based upon said at least one trigger; and
causing said middleware to operate in accordance with said second behavior set.

20. A system comprising at least one middleware server and at least one middleware client, each operative in accordance with the method of claim 1.
